(19) United States
(12) Patent Application Publication
(10) Pub. No.: US 2013/0189437 A1
(43) Pub. Date: Jul. 25, 2013

(54) SPRAY PAINTING

(71) Applicants: Mark Williams, Victoria (AU); Jim Vais, Victoria (AU)

(72) Inventors: Mark Williams, Victoria (AU); Jim Vais, Victoria (AU)

(73) Assignee: LOWBAKE AUSTRALIA PTY LTD, Dandenong, Victoria (AU)

(21) Appl. No.: 13/812,923

(22) PCT Filed: Aug. 25, 2011
(86) PCT No.: PCT/AU2011/001097

§ 371 Date: Mar. 19, 2013

(30) Foreign Application Priority Data
Aug. 25, 2010 (AU) 2010903816

(51) Int. Cl. B05B 15/12

(52) U.S. Cl. CPC B05B 15/1296
USPC 427/372.2; 239/135

(57) ABSTRACT

An apparatus for the application of paint to an article (2) includes means (20) adapted to have one or more articles (2) removably located and retained thereon at predetermined position, an enclosure (20) which extends around the or each article (2), with that enclosure 20 including peripheral walls (31, 32) and an associated roof or top cover (33) with one or more radiant heating assemblies mounted to the enclosure (30) and means allowing for controlled movement of the enclosure (20) relative to the article retaining means (20) substantially transversely thereof.

### FIELD OF THE INVENTION

The present invention relates, in general terms, to improvements in spray painting equipment and procedures. More particularly, but not exclusively, the invention relates to an improved spray paint booth or enclosure and to a method for the spraying of any given item utilising such an improved booth or enclosure.

Throughout the ensuing specification reference will be made, in particular, to an especially preferred embodiment of the invention, namely an improved spray booth or enclosure for use in the application of paint to automobiles and/or parts thereof. It should be understood, however, that such is given only by way of example of a preferred embodiment of or context of usage for the apparatus and method in accordance with the present invention, and the invention is not to be considered to be in any way limited or restricted to the or any preferred embodiment and/or context of usage as described in detail hereinafter.

### BACKGROUND OF THE INVENTION

Paint spray booths or enclosures are commonly found in production lines for products such as, for example, automobiles. Booths of this type may also be found on premises used for the repair of damaged automobiles, such as for example panel-beating workshops or the like. In fact, such booths or enclosures may be found in any locale where paint or the like is required to be deposited on a product or article.

In accordance with known techniques and practices parts of an automobile, or indeed an entire automobile, which must be painted or need to be re-painted will be conveyed into a fixed booth or enclosure, with the desired paint then being applied within such booth or enclosure using known techniques, as for example by spraying onto the parts and/or the automobile in general, either manually or through the use of robotics or the like. The prior art arrangements have all involved the utilisation of a fixed/permanent spray booth or enclosure, with the parts to be sprayed, or the automobile to be sprayed, being movable into and out of such spray booth/enclosure for purposes of spraying and/or initial curing, and subsequently being moved/removed therefrom to a remote location to allow for final curing, washing, buffing or whatever other operation is necessary in order to give rise to a finished product.

Such prior art arrangements, utilising fixed booths, enclosures or the like, have been found to suffer in terms of there existing an enhanced possibility of unwanted contamination—as for example by contact with people, other items of equipment, etc.—during movement of the painted vehicle/automobile therefrom, this especially in the instance where final curing of the applied paint has not yet occurred. Such prior art fixed booths have also suffered from the disadvantage of being extremely expensive pieces of equipment in terms of their manufacture and installation. In this day and age, when production-line techniques are ever more desirable and it is preferred, as for example in a panel-beating workshop or the like, to be able to work on a number of different vehicles individually or in sequence, a fixed booth of this type suffers in terms of flexibility of use. Indeed it has been determined that a much more effective and efficient operation would be possible if, rather than involving a fixed booth or enclosure having automobiles in sequence moved thereinto and therefrom, an arrangement was to be employed wherein a booth or the like enclosure could be moved sequentially between vehicles, without it being necessary for the vehicles to be actually moved, until such time as painting and subsequent final curing has occurred. With such an arrangement, including a movable spray booth or enclosure, the likelihood of unwanted contamination of a not-fully-cured paint job should be minimised, if not actually removed altogether.

An arrangement in accordance with the present invention, including a movable booth or enclosure having appropriate drying means—as for example infra-red and/or gas radiation means—associated therewith, further acts to reduce the residence time of any automobile within the booth or enclosure itself.

The arrangement in accordance with the present invention, with its movable booth or enclosure, also serves to maximise the use of that booth or enclosure, in turn improving the efficiency of operation of the overall workshop, manufacturing-line etc.

In accordance with an aspect of the present invention, therefore, there is provided an improved paint spray booth or the like enclosure, including: a floor, deck or the like, which is substantially horizontal and is adapted to have located thereon, at predetermined positions, one or more products which require paint to be sprayed thereon; an enclosure, adapted to extend substantially normally to said floor, deck or the like and to be disposed around said one or more product, said enclosure including peripheral walls and an associated roof or top cover; one or more radiant heating assemblies adapted to be associated with said enclosure, preferably with the roof or top cover thereof; and means allowing for controlled movement of said enclosure relative to said floor, deck or the like and substantially transversely thereof.

In accordance with another aspect of the invention there is provided a method for the spray painting of a product, utilising an improved paint spray booth or enclosure of the type referred to in the preceding paragraph.

### DESCRIPTION OF THE DRAWINGS

In order that the invention may be more clearly understood and put into practical effect reference will now be made to an especially preferred embodiment of an apparatus and method in accordance with the present invention. The ensuing description is given by way of non-limitative example only and is with reference to the accompanying drawings, wherein:

FIGS. 1a, 1b and 1c are perspective views of a spray booth or enclosure in accordance with the known prior art, showing a vehicle/automobile during various stages in the operation thereof;

FIGS. 2a to 2f are views, similar to FIGS. 1a to 1c, but of a spray booth or enclosure in accordance with a preferred embodiment of the present invention, in this instance showing how the booth/enclosure is employed during painting of two separate vehicles/automobiles;

FIG. 3 is a top perspective view of the enclosure/booth as shown in FIGS. 2c to 2f, but without a roof or the like in place thereon;

FIG. 4 is a sectional view of a column or corner member of the enclosure/booth of FIG. 3; and

FIG. 5 is a cross-sectional view of the enclosure of FIG. 3.

### DESCRIPTION OF PREFERRED EMBODIMENT

A spray booth or enclosure in accordance with the present invention is especially suited for the application of paint, as by spraying, to an automobile or the like vehicle. Hereinafter the invention will be particularly described with regard to such a preferred context of usage. It should be understood, however, that the method and apparatus in accordance with the present invention will be equally suited to use in any situation or context wherein paint or the like is to be applied to any products in, for example, a production line situation.

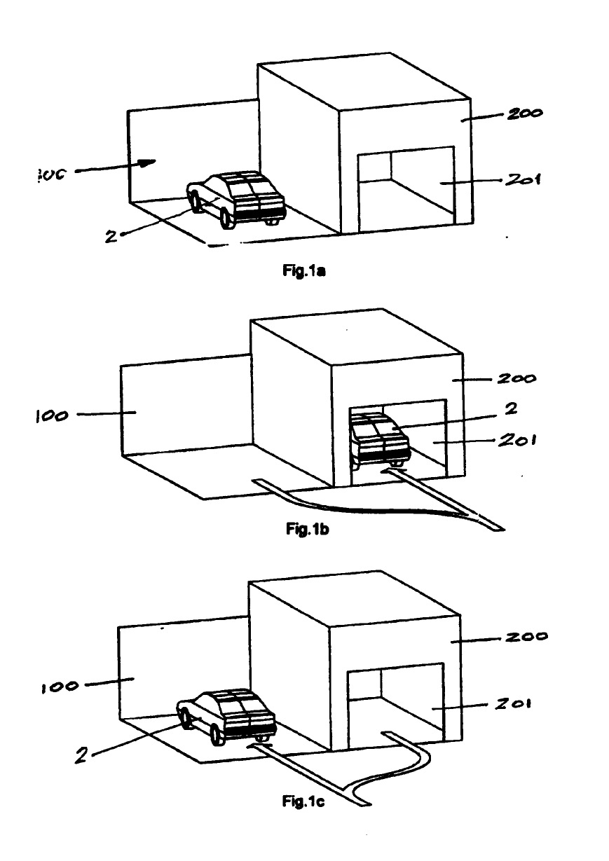

With reference firstly to FIGS. 1 a to 1c of the drawings, such are top perspective views of a spray booth or enclosure in accordance with the known art. The arrangement shown therein, particularly suited for use in a panel-beating works or car repair works, includes a preparation bay, generally designated 100, and a spray booth or enclosure generally designated 200, both appropriately located on a given surface 3, as for example the floor of a building or the like or, in an alternative embodiment (not shown), an area of decking or other material The spray booth 200, of the non-movable type, includes an opening or portal 201 through which an automobile 2 may be driven or moved, firstly from the preparation bay 100 to the spray booth 200 for spray painting, and thereafter out of the spray booth 200 back to the preparation bay 100 for subsequent treatment or handling (as for example airing, washing, etc.)

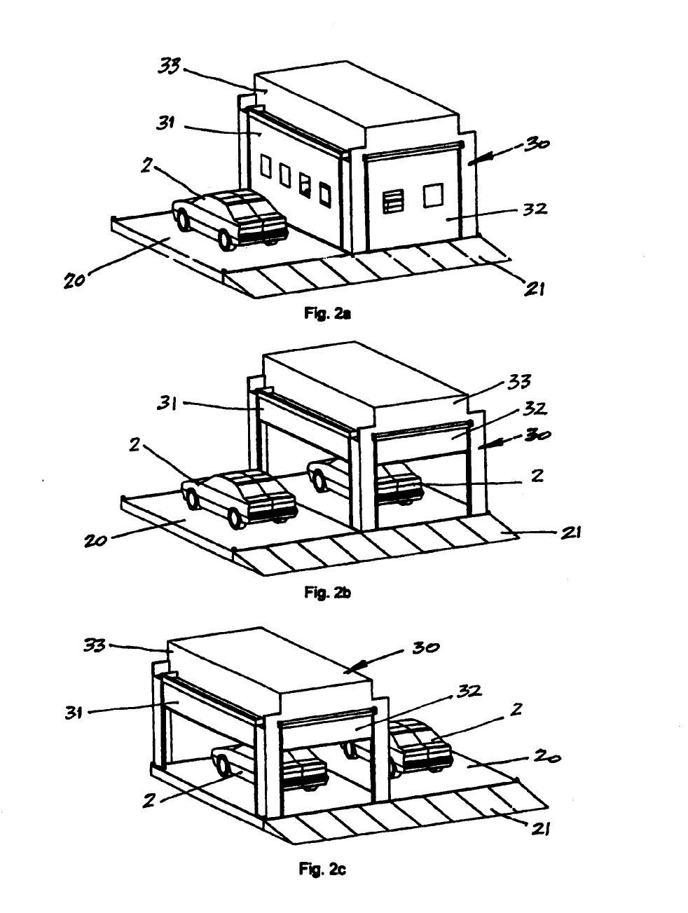

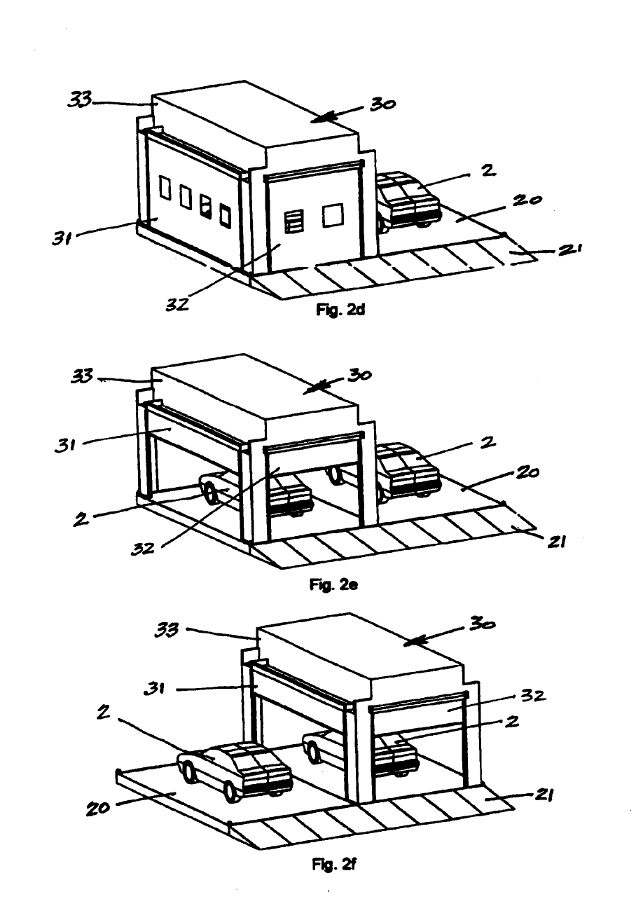

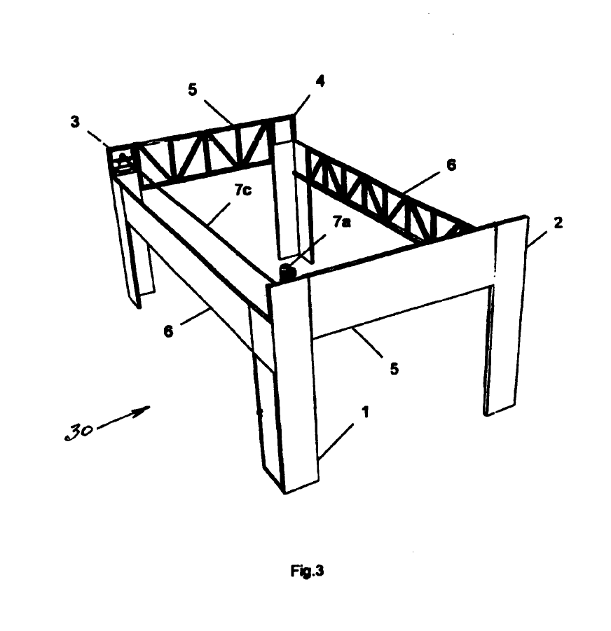

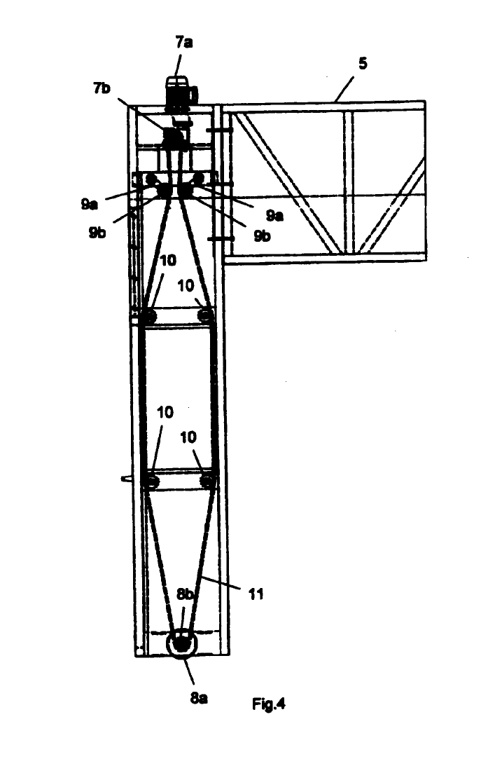

Turning then to FIGS. 2a to 2f inclusive, such show an apparatus in accordance with the present invention which includes, as principal components, a deck or platform means 20, substantially horizontally disposed, adapted to have located thereon (and removable therefrom as and when desired) one or more vehicles 2. To assist in location of the vehicle(s) 2 on the deck or platform means 20, ramps or the like 21 may be provided extending along at least part of the length dimension of at least one side of the deck or platform means 20.

The arrangement further includes a booth or enclosure 30 which is adapted, in use, to be movable—in any known manner and using any known means—substantially transversely of the deck or platform means 20 between the position shown in, for example, FIGS. 2a, 2b and 2f and that shown in FIGS. 2c, 2d and 2e without in any way impinging on or coming into contact with a vehicle disposed on the deck 20. As can be seen, when in the position shown in FIGS. 2a, 2b and 2f, the booth or enclosure 30 will allow for treatment/painting of a first vehicle 2 located on the deck or platform means 20, whilst when in the position shown in FIGS. 2c, 2d and 2e treatment/painting can be carried out on a second vehicle 2.

As can be seen from FIGS. 2a to 2f, the booth or enclosure 30 includes opposed pairs of side walls 31, end or closure walls 32 and a roof assembly 33 extending therebetween. Preferably the side walls 31 and end or closure walls 32 may be retractable, between the positions shown in FIGS. 2a and 2b, for example, to allow for transverse movement of the booth or enclosure 30 relative to the deck 20 over any vehicle 2 disposed thereon without impinging on or contacting such vehicle 2. The actual mode of construction of both the pairs of side walls 31 and end walls 32 is not of the essence of the invention. In one embodiment, for example, they could each be in the form of a roller-door type construction, of the type commonly used nowadays in a variety of different contents. In an alternative embodiment they could be constructed from a suitable flexible material, in the form of a curtain, adapted to be lifted as and where necessary so as not to impinge on any vehicle during movement of the booth 30. In that regard it should be understood that a function of the booth or enclosure 30 is to allow for spray painting of a vehicle 2 located therewithin, whilst at the same time preventing unwanted egress of paint therefrom.

Turning then to FIG. 3, there is shown therein a preferred embodiment of a movable booth or the like enclosure 30 in accordance with the invention. Such includes, as principal components, respective frame corner columns 1, 2, 3 and 4. Preferably the columns 1, 2, 3 and 4 will be constructed from a suitable metallic material, as for example steel. However, the actual material of construction is not of the essence of the invention. In the especially preferred embodiment illustrated the respective pairs of frame corner columns 1, 2, 3 and 4 may be jointed together by trusses or the like 5 and 6, also preferably constructed from steel or the like material.

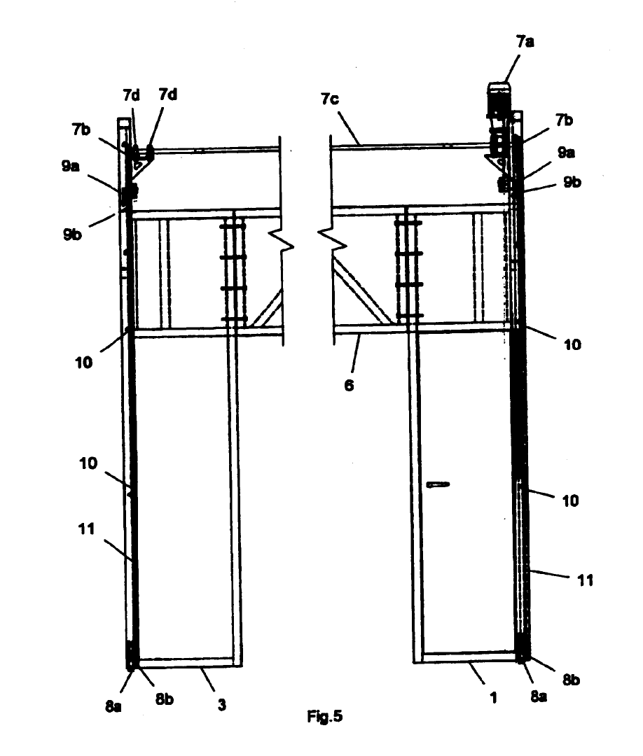

Each of such columns 1, 2, 3 and 4, as shown in more detail for example in FIG. 4, has associated therewith means which allow for the overall booth/enclosure 30 to be moved transversely—in a controlled manner—between the two end positions on the deck 20 as shown in FIGS. 2a and 2e, for example.

In the preferred embodiment illustrated, and in that regard reference is made to FIGS. 4 and 5, one or more of the columns 1 to 4 may have a drive train or the like included therewithin/associated therewith. Such drive train can include, as principal components, a driving wheel 8a (preferably grooved) which is located at or in the vicinity of the base of each column 1 to 4, or selected ones thereof, and an associated drive sprocket 8b (also preferably grooved), with the driving wheel 8a being adapted to be located, for movement, relative to a rail or complementary grooved element (not shown) disposed laterally of the deck 21. At or in the vicinity of the top of the (or each) column 1 to 4 there is provided a power source of any known type, as for example a geared drive motor 7a (of any known type). It should be understood, however, that the actual type of power source is not of the essence of the invention.

A drive chain 11, in drive connection with the power source 7a, extends downwardly of the or each column and co-operates with a plurality of roller chain idler sprockets 9b strategically located along the height dimension of the associated column. Preferably a plurality of roller chain tensioning arms 9a, with associated tensioning arm roller sprockets, will also be employed. At or in the vicinity of the upper end of the or each column is located a primary transmission chain drive sprocket 7b. Interposed along the height dimension of the column are a plurality of transmission chain roller sprockets 10.

The principle of operation of the improved booth or spray enclosure 30 in accordance with the present invention is as explained hereinafter.

When one, or more, vehicles 2 is, or are, disposed on the deck 20, the driving means for the booth 30 will be operated to dispose such enclosure over/around the or a first of such vehicle or vehicles. The side and end walls 31, 32 may then be lowered to the position shown in, for example, FIG. 2a, and spray equipment housed or located—in any known manner—within the booth 30 may be activated to apply the desired quantity of paint to the vehicle 2 resident with the booth 30, or to selected areas or parts thereof. Upon completion of the spraying process, then curing means also located within the booth 30, as for example infra-red heaters and/or gas radiators, may be activated for purposes of drying/curing the paint. Thereafter, when drying/curing is completed the or selected ones of the side and end walls 31, 32 may be raised to, for example, the position shown in FIG. 2b, and the drive means activated to move the enclosure transversely of the deck 20 to, for example, the position shown in FIG. 2c, disposed around a different vehicle 2. The cycle can then be repeated on that different vehicle, with the first vehicle then being removed from the deck 20 and replaced by another.

With the apparatus of the present invention, the enclosure will preferably have associated therewith means which allows for ventilation thereof, as and when required. Any known type of ventilation means or system may be utilized, and this does not constitute part of the invention.

The movable enclosure, with its including heating/curing means, has been found to result in paint as applied to an automobile being fully cured—to an extent to allow for buffing (if required, washing or the like—in a very short period of time (perhaps as little as within minutes). This is in contrast to more conventional spray paint booths, which utilise mere heated air for purposes of drying or curing, wherein full curing may not take place for some 12 to 24 hours.

In accordance with known techniques multiple fixed booths could be employed to increase throughput. However such arrangements are expensive, and therefore not particularly suitable for smaller scale operations. The movable arrangement of the present invention allows for improved throughput, at reduced capital cost.

The apparatus may also include an effective/efficient means for the supply of air, preferably with a high downdraft air flow. In an especially preferred embodiment (not shown) an air flow control system may be incorporated to create a reduced internal air pressure within the enclosure when in use.

The following are some advantages attributable to the apparatus in accordance with the present invention, when compared with the prior art:

(i) the entire paint repair needed to a given automobile can be effected/completed without it being necessary to actually move the automobile, leading to a decrease in repair time and a reduction in the possibility of unwanted contamination of a not fully cured paint job;

(ii) a significant saving in both acquisition/installation and operational running costs, since in effect the booth in accordance with the present invention does the same job for which two or more fixed-type booths may have previously been necessary;

(iii) a significant saving in workshop floorspace, since prior art arrangements with static/immobile booths required greater floorspace to allow for automobile movement.

Finally, it is to be understood that the aforegoing description refers merely to preferred embodiments of the invention, and that variations and modifications will be possible thereto without departing from the spirit and scope of the invention, the ambit of which is to be determined from the following claims.

1. An apparatus for the application of paint to an article, said apparatus including: means adapted to have one or more articles removably located and retained thereon at predetermined positions; an enclosure, adapted to extend substantially normally to the or each said article retaining means and to be disposed around said one or more articles, said enclosure including peripheral walls and an associated roof or top cover; one or more radiant heating assemblies adapted to be mounted to said enclosure; and means allowing for controlled movement of said enclosure relative to said article retaining means, substantially transversely thereof.

2. The apparatus as claimed in claim 1, wherein said article retaining means is a floor, deck or the like, adapted to be located within a given structure.

3. The apparatus as claimed in claim 2, including ramp means associated with said floor, deck or the like.

4. The apparatus as claimed in claim 3, wherein the or each said radiant heating assembly is a gas radiator appropriately located within said enclosure and adapted to be movable therewith.

5. The apparatus as claimed in claim 4, wherein said article is a vehicle, automobile or the like apparatus for locomotion by land.

6. The apparatus as claimed in claim 4, wherein the article is a component of a vehicle, automobile or the like apparatus for locomotion by land.

7. The apparatus as claimed in claim 5, wherein one or more of said peripheral walls are adapted to be selectively and progressively movable between respective lowered (closed) and elevated (open) configurations, whereby to allow said enclosure to move relative to said article retaining means without in any way impinging on the article housed therewithin.

8. The apparatus as claimed in claim 7, wherein said enclosure is comprised of opposed pairs of longitudinal and transverse walls, forming a parallelpipedal enclosure having said roof or top cover associated therewith.

9. The apparatus as claimed in claim 8, wherein said enclosure includes four corner columns having said longitudinal and transverse walls extending themselves, and wherein at least one of said corner columns has associated therewith means allowing for selective and controlled movement of said enclosure relative to said article retaining means.

10. The apparatus as claimed in claim 9, wherein said at least one of said column has a drive train located internally thereof.

11. The apparatus as claimed in claim 10, wherein said drive train includes at least one driving wheel which is located at or in the vicinity of said at least one column, said at least one driving which being adapted, in use, for movement relative to a rail or the like disposed on said floor, deck or the like and preferably extending transversely thereof, whereby to give rise to movement of said enclosure relative to said floor, deck or the like.

12. The apparatus as claimed in claim 11, including a power source disposed at or in the vicinity of the top of said at least one column, said power source co-operating with a drive chain in drive connection with said drive wheel.

13. The apparatus as claimed in claim 12, wherein said power source is a geared drive motor.

14. A method for the spray-painting of an automobile, using the apparatus as claimed in claim 1, said method including the steps of:
locating one or more automobiles or other articles on said article retaining means;
moving said enclosure transversely to be located over one of said automobiles or other articles;
effecting a spray-painting and curing procedure on said automobile or other article located within said enclosure; and
thereafter moving said enclosure away from said painted automobile or other article to be disposed over another automobile or other article located on said article retaining means.
